(19) United States
(12) Patent Application Publication
(10) Pub. No.: US 2024/0369688 A1
(43) Pub. Date: Nov. 7, 2024

(54) LIDAR SENSOR AND ENVIRONMENT RECOGNITION SYSTEM

(71) Applicant: Robert Bosch GmbH, Stuttgart (DE)

(72) Inventor: Norman Haag, Stuttgart (DE)

(21) Appl. No.: 18/576,183

(22) PCT Filed: Jul. 7, 2022
(86) PCT No.: PCT/DE2022/100486

§ 371 Date: Jan. 3, 2024

(30) Foreign Application Priority Data
Jul. 8, 2021 (DE) 10 2021 207 227.5

(51) Int. Cl. G01S 7/481; G01S 7/497; G01S 17/89; G01S 17/93

(52) U.S. Cl. CPC G01S 7/4816; G01S 7/4813; G01S 17/89; G01S 17/93; G01S 2007/4977

(57) ABSTRACT

A lidar sensor and an environment recognition system. The lidar sensor includes: a transmission unit, a protective glass, an objective, a microlens arrangement, and a detector. The transmission unit is configured to generate a laser light and radiate it into an environment of the lidar sensor. The protective glass, the objective, the microlens arrangement, and the detector are arranged in a reception path of the lidar sensor. The objective is configured to image objects from the environment. The microlens arrangement is between the objective and the detector in such a way that scattered light generated in the region of the protective glass and useful light received from the environment are influenced by the microlens arrangement so that a separate use of the scattered light and of the useful light is made possible. The detector is configured to convert light influenced by the microlens arrangement into a measurement signal.

### FIELD

The present invention relates to a lidar sensor and an environment recognition system having such a lidar sensor.

### BACKGROUND INFORMATION

Some lidar sensors in the related art ascertain a transit time of the laser light between a distant object and the lidar sensor by means of emitted laser light via direct and/or indirect measurement methods in order to ascertain a distance between the object and the lidar sensor on the basis of the transit time. Typically, such lidar sensors aim at long ranges in the range of about 100 m to 300 m. An important aspect, in particular for an environment recognition system on the basis of the lidar sensor, is that only the light actually scattered back from the distant object is detected by the lidar sensor and, if possible, no or only a small scattered light portion that can, for example, be caused by a protective glass of the lidar sensor or by contaminations and/or defects of such a protective glass.

Some plenoptic cameras in the related art are capable of detecting not only a light intensity at a position at which a light beam impinges on a detector of the camera but also the direction from which the light beam impinges. This, for example, allows a later shifting of the sharpness plane of an image captured by means of a plenoptic camera.

German Patent Application No. DE 10 2017 210 684 A1 inter alia describes a detector arrangement, comprising an optical waveguide and a detector unit, for a lidar system. In one design variant, the optical waveguide comprises an angle-selective element. This angle-selective element is designed to select a particular wavelength range and a particular angle range or field-of-view range in such a way that only backscattered light from this particular angle range or field-of-view range is guided to the optical waveguide.

German Patent Application No. DE 10 2019 123 702 A1 describes a LIDAR system for detecting the distance of an object, which system inter alia includes a segmented lens positioned on the center line between a first portion of a reception beam and a second portion of the reception beam. In some examples, the segmented lens comprises a first surface forming the transmission lens segment and a second surface forming the reception lens segment, wherein the first surface and the second surface are connected via continuous transitions in order to achieve a reduction in scattered light.

### SUMMARY

According to a first aspect of the present invention, a lidar sensor is provided, which is, for example, a lidar sensor for a means of transportation. Such a means of transportation is, for example, a road vehicle (e.g., a motorcycle, a passenger car, a van, a truck) or a rail vehicle, or an aircraft/airplane, and/or a watercraft, without thereby being restricted to a lidar sensor for a means of transportation.

The lidar sensor comprises a transmission unit, a protective glass, an objective, a microlens arrangement (also referred to as a microlens array), and a detector. The transmission unit comprises, for example, a laser diode or a laser diode arrangement and is configured to generate a laser light and to radiate it via a transmission path of the lidar sensor.

For example, the protective glass is made of glass and/or plastic and is preferably integrated into an outer wall of a housing of the lidar sensor in a hermetically sealed manner. The protective glass serves as an environment interface of the lidar sensor and protects the components of the lidar sensor inside the housing from environmental influences (e.g., dirt, wetness, moisture, etc.) while being transmissive to a wavelength range of the generated laser light and accordingly serving as the light inlet opening and as the light outlet opening of the lidar sensor. It is possible that the protective glass is formed in one piece and simultaneously serves as a light inlet opening and light outlet opening or that it is formed in multiple pieces, wherein a portion of the protective glass serves as a light inlet opening and a different portion of the protective glass serves as a light outlet opening.

The transmission path of the lidar sensor is accordingly composed at least of the transmission unit and the protective glass, while a reception path of the lidar sensor is composed at least of the protective glass, the objective, the microlens arrangement and the detector.

The objective, which is constructed of a single collecting lens or preferably of an arrangement of several beam-forming optical elements, is configured to image objects from the environment of the lidar sensor, which objects are illuminated in the environment by the radiated laser light of the lidar sensor and scatter this laser light at least proportionately toward the reception path of the lidar sensor. Typically, objectives in reception paths of lidar sensors are designed in such a way that distant objects, e.g., at distances of up to 100 m, up to 200 m, up to 300 m or more, are imaged sharply on the detector of the lidar sensor (i.e., the objective is substantially designed for light beams impinging in parallel, i.e., for an infinite object width). Unless otherwise mentioned, the following mentioned sharpness planes of the environment essentially refer, in the sense of a simplified description, to the aforementioned distances or object widths, wherein a design of the objective for shorter object widths is thereby explicitly not excluded.

According to an example embodiment of the present invention, the microlens arrangement is arranged between the objective and the light detector in such a way that scattered light generated in the region of the protective glass (e.g., due to rain drops or dirt particles, etc. present on the surface of the protective glass) and useful light received from the environment (i.e., portions of the emitted laser light that were backscattered on objects in the environment) are influenced by the microlens arrangement in such a way that a substantially separate use of the scattered light and of the useful light is made possible.

According to an example embodiment of the present invention, the detector is configured to receive light influenced by the microlens arrangement and to convert it into a corresponding measurement signal.

In addition to the advantage, provided by the lidar sensor according to the present invention, of a separate possible use of the scattered light and of the useful light, the use according to the present invention of the microlens arrangement offers the advantage that an overall length of a design of the optical paths of the lidar sensor is only insignificantly increased.

It should be pointed out in general that a transit time measurement of the emitted laser light for determining the distance of objects in the environment of the lidar sensor, which is typical for lidar sensors, is in no way restricted by the lidar sensor according to the present invention and is, on the contrary, preferably provided.

Preferred developments of the present invention are disclosed herein.

In an advantageous embodiment of the present invention, the microlens arrangement is a regular, in particular a grid-like, arrangement of a multitude of identical microlenses within a plane, wherein deviating designs of the microlens arrangement are also possible, in which, for example, at least partially an irregular arrangement of the individual microlenses and/or at least partially a different form of the individual microlenses of the microlens arrangement is used. Alternatively, or additionally, the microlens arrangement is arranged between the objective and the light detector in such a way that it is substantially in an image plane, generated by the objective, of the protective glass. The latter offers the special advantage that scattered light generated by the protective glass, which scattered light is generated, for example, due to a locally limited defect of the protective glass, is imaged sharply in the arrangement plane of the microlens arrangement (i.e., the image plane of the protective glass), which is why this plane is particularly suited to separate the scattered light from the useful light since useful light that is present in this arrangement plane and whose light beams are aligned substantially parallel to one another is imaged blurrily.

Providing the arrangement of the microlens arrangement “substantially” in the image plane of the protective glass means that, in addition to using the plane in which an optimally sharp imaging of the protective glass takes place, a plane deviating slightly therefrom can also be used for the arrangement of the microlens arrangement as long as an associated, less sharp imaging of the protective glass is sufficient to be able to separately consider the scattered light from the useful light.

In a further advantageous embodiment of the present invention, the lidar sensor additionally comprises an aperture mask corresponding to the microlens arrangement, wherein the aperture mask is arranged between the microlens arrangement and the detector and is configured to limit an aperture for each microlens of the microlens arrangement in such a way that potentially present scattered light portions are reduced by the limited aperture. This exploits the effect that the scattered light caused by the protective glass generally impinges on the microlenses of the microlens arrangement at greater angles than the useful light impinging from a further distance and, after passing through the respective microlenses, is thus more prevalent than the useful light in regions that are at a further distance from the optical axis of the respective microlens than the useful light. By blocking these regions by means of the aperture mask, the scattered light portion in the useful light can be reduced accordingly.

Particularly preferably, the lidar sensor furthermore comprises an evaluation unit, which is designed, for example, as an ASIC, FPGA, processor, digital signal processor, microcontroller, or the like. In addition, a reception surface (i.e., a light-sensitive surface) of the detector is preferably arranged in the respective focal planes of the microlenses of the microlens arrangement, without being restricted to this arrangement. Furthermore, the evaluation unit is configured to receive the measurement signal of the detector and, on the basis of the principle of light-field imaging by means of a light-field camera (also called a plenoptic camera), to generate a useful light signal from the measurement signal, which useful light substantially represents the useful light portion of the received light, and/or to generate a scattered light signal, which substantially represents the scattered light portion of the received light. This is made possible in that information about the angles of incidence of light beams is additionally obtained through the respective microlenses of the microlens arrangement, on the basis of which information it is possible to subsequently ascertain images with different sharpness planes in the object space (e.g., respectively for the distant environment and the protective glass). In a case in which the reception surface of the detector is arranged in the respective focal planes of the microlenses, the measurement signal of the detector represents image information in which the protective glass is imaged sharply in that brightness information of those pixels of the reception surface that are associated with a respective microlens is respectively added up. Image information in which the environment to be detected by means of the lidar sensor is imaged sharply can accordingly be reconstructed on the basis of the measurement signal in accordance with the principle of light-field imaging. This inter alia provides the advantage that only one of the desired sharpness planes must be reconstructed on the basis of the measurement signal. In a case in which the reception surface is arranged outside the focal plane of the microlenses, it is possible by means of an increased computational effort to subsequently reconstruct both the sharpness plane of the protective glass and the sharpness plane of the environment. In addition, it is possible in this way to reconstruct further sharpness planes of any further existing causes of scattered light.

Preferably, according to an example embodiment of the present invention, the evaluation unit is configured to ascertain a magnitude of the scattered light portion on the basis of a brightness distribution, in particular a width of a brightness distribution on the reception surface of the detector. For this purpose, for example, a local brightness distribution on the reception surface of the detector is ascertained for each microlens in that respective brightness information of those pixels that are associated with a respective microlens are evaluated together. This is based on the assumption that, in the case of a non-existent or only small scattered light portion, those pixels associated with a microlens that correspond to the region of the optical axis of the respective microlens predominantly have high brightness values (which are, for example, above a predefined threshold value), while, in the case of a clearly existing scattered light portion, even the pixels that correspond to regions of the respective microlens that have a greater distance from the optical axis of the respective microlens provide high brightness values. In other words, in the case of a small or non-existent scattered light portion, a smaller local spread of the light impinging on the reception surface of the detector is to be expected than in the case of an existing or high scattered light portion. Alternatively, or additionally, it is possible to ascertain the magnitude of the scattered light portion on the basis of a light intensity difference between pixels on the reception surface of the detector. This is based on the assumption that an existing scattered light portion illuminates one or more adjacent pixels with an intensity that is, for example, above an average light intensity of a multitude of pixels. Those pixels that have such an above-average light intensity can accordingly be interpreted as scattered light. Depending on the magnitude of an absolute and/or relative light intensity of such pixels, a magnitude of the scattered light portion can thus be derived. Furthermore, it is possible to reduce these scattered light portions in a useful signal to be ascertained on the basis of the measurement signal, in that brightness information of pixels with above-average light intensity is replaced or averaged, for example using brightness information of adjacent pixels, or in that the brightness information of these pixels is, for example, discarded. Moreover, further possibilities are possible for reducing the scattered light portions in the measurement signal of the detector or for removing them therefrom.

According to an example embodiment of the present invention, alternatively, or additionally, the evaluation unit is configured to ascertain a cause of the scattered light portion and/or a position of the cause of the scattered light portion in the region of the protective glass using an image recognition method. Using image information that is based on the measurement signal of the detector and represents the sharpness plane of the protective glass, it is, for example, possible to identify typical contaminations (e.g., rain, dust, etc.) and/or defects (e.g., fallen rocks, scratches, etc.) of the protective glass by means of image recognition methods from the related art. This takes place, for example, by means of an evaluation of contours of contaminations and/or defects and/or further typical features, wherein a classification of respective contaminations and/or defects can inter alia be carried out by means of a feature classification method and/or a machine learning method, etc.

Advantageously, the evaluation unit is configured, depending on the magnitude and/or the cause and/or the position of the cause of the scattered light portion, to initiate a cleaning of the protective glass, in particular a partial cleaning of the protective glass corresponding to the position of the cause of the scattered light portion, and/or to output an indication to a user of the lidar sensor (e.g., acoustically and/or visually and/or haptically) and/or to output a signaling to a system that uses the lidar sensor. Such a system that uses the lidar sensor is, for example, an environment recognition system of a vehicle, which, on the basis of information about existing scattered light portions, makes, if necessary, adjustments to environment recognition parameters and/or adjustments to driving modes and, if necessary, further adjustments.

In a further advantageous embodiment of the present invention, the microlens arrangement is a first microlens arrangement and the lidar sensor moreover comprises a second microlens arrangement in addition to the aperture mask described above, wherein the second microlens arrangement is arranged between the aperture mask and the detector and is configured to generate a back image, corresponding to the image by the first microlens arrangement, on the reception surface of the detector. This is advantageously applicable, for example, if it is not necessary to detect, by means of the detector, information regarding a scattered light portion caused in the region of the protective glass, so that, on the basis of the above configuration, scattered light portions can be filtered directly by means of the aperture mask, while a sharp image of the environment of the lidar sensor is generated on the reception surface of the detector by the second microlens arrangement. This can, for example, save computing resources since a subsequent calculation of the sharpness plane of the environment and of the sharpness plane of the protective glass on the basis of the measurement signal is not required.

Advantageously, the lidar sensor is a flash lidar or a line scanner, without thereby being restricted to these specific embodiments.

According to a second aspect of the present invention, an environment recognition system is provided, which comprises a lidar sensor according to the above description. The environment recognition system is advantageously an environment recognition system of a means of transportation, in particular of a vehicle (e.g., passenger car, truck, rail vehicle, two-wheeler, etc.) that is enabled on the basis of the lidar sensor according to the present invention to carry out a more reliable and safer environment recognition since undesired scattered light restricting a field of view of the environment sensor can be separated from the useful light. The features, feature combinations and the resulting advantages correspond to those listed in connection with the first-mentioned aspect of the present invention, in such an obvious manner that reference is made to the above statements in order to avoid repetitions.

### BRIEF DESCRIPTION OF THE DRAWINGS

Exemplary embodiments of the present invention are described in detail below with reference to the figures.

FIG. 1 shows a schematic overview of a lidar sensor according to an example embodiment of the present invention.

FIG. 2 shows a schematic partial view of a reception path of a lidar sensor according to an example embodiment of the present invention.

### DETAILED DESCRIPTION OF EXAMPLE EMBODIMENTS

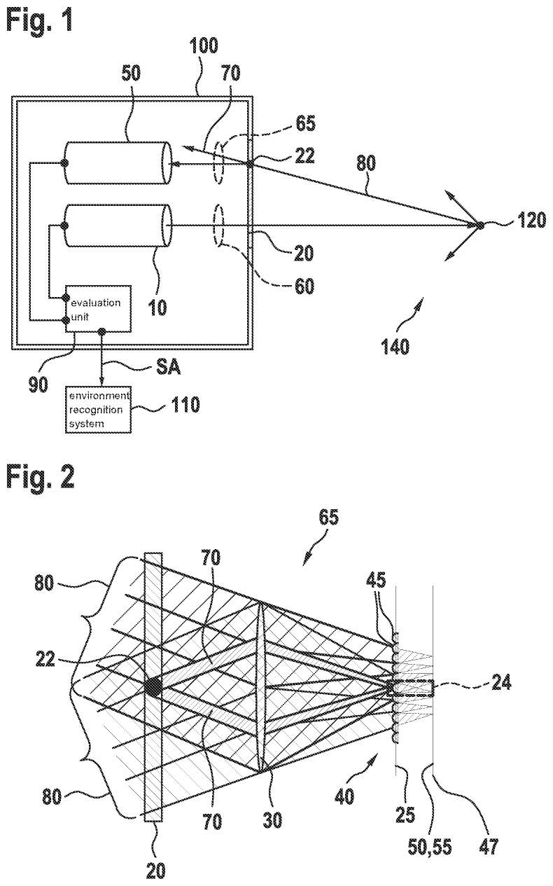

FIG. 1 shows a schematic overview of a lidar sensor according to the present invention designed as a line scanner, for a vehicle having a transmission unit 10 configured to emit laser light into an environment 140 of the lidar sensor via a transmission path 60. The lidar sensor has a housing 100 in which a protective glass 20, which is transmissive to the laser light, is integrated, wherein the protective glass 20 functions as the light inlet interface and light outlet interface of the lidar sensor.

The emitted laser light is proportionally scattered back as the useful light 80 to the lidar sensor by an object 120 in the environment 140. Due to a defect 22 in the protective glass 20, the useful light 80 is partially scattered when entering the lidar sensor, whereby undesired scattered light 70 is generated in the reception path 65 of the lidar sensor.

The scattered light is influenced by means of a microlens arrangement 40 (not shown, explained in more detail in FIG. 2) arranged between an objective 30 (not shown, explained in more detail in FIG. 2) and a detector 50 of the lidar sensor, in such a way that a substantially separate use of the scattered light 70 and of the useful light 80 is made possible. The detector 50 is configured to receive the light, influenced by the microlens arrangement 40, from the environment 140 and to convert it into a corresponding measurement signal.

Moreover, the lidar sensor comprises an evaluation unit 90, which is designed here as an ASIC and is connected by information technology to the transmission unit 10 and the detector 50. In this way, the evaluation unit 90 is able to define or detect respective laser transmission times in the transmission unit 10 (e.g., for a transit time measurement of the laser light) and to receive the measurement signal generated by the detector 50.

The evaluation unit 90 is also configured to ascertain a magnitude of a scattered light portion 70 on the basis of a width of a brightness distribution on a reception surface 55 (not shown, explained in more detail in FIG. 2) of the detector 50.

Furthermore, the evaluation unit 90 is configured to ascertain a cause of the scattered light portion 70 (here the defect 22) and a position of the cause of the scattered light 70 by means of an image recognition method.

On the basis of the information about the magnitude and the position of the scattered light portion 70, the evaluation unit 90 is also configured to output a warning to a user, e.g., to a driver of the vehicle, and to output a signaling by means of an output signal SA to an environment recognition system 110 of the vehicle. In this way, the driver is notified of the defect 22 so that the driver can, for example, initiate a repair of the protective glass 20, while the environment recognition system 110 can, for example, use the information about the defect to suitably adapt the currently used environment recognition parameters to the current situation.

FIG. 2 shows a schematic partial view of a reception path 65 of a lidar sensor according to the present invention. The reception path 65 shows a protective glass 20 of the lidar sensor, via which protective glass light beam bundles impinging substantially in parallel (and representing a useful light 80) impinge on an objective 30 of the lidar sensor. Due to local contamination 22 of the protective glass 20, resulting scattered light portions 70 of the impinging useful light 80 are substantially bundled in a main scattered light region 24 on a reception surface 55 of a detector 50 of the lidar sensor by the objective 30 and microlenses 45 of a grid-like microlens arrangement 40. Due to an arrangement of the microlens arrangement 40 in a plane between the objective 30 and the detector 50, which plane corresponds to an image plane 25 of the protective glass 20, the surface of the protective glass 20 in the plane of the microlens arrangement 40 is accordingly imaged sharply.

Since the reception surface 55 is also arranged in the focal plane 47 of the microlenses 45 of the microlens arrangement 40, only a small portion of pixels of the reception surface 55 are accordingly illuminated by the scattered light portions 70, as a result of which they can be detected and reduced by means of an evaluation unit 90 (not shown), which is connected by information technology to the detector 50.

Furthermore, it is possible to insert an aperture mask (not shown) between the microlens arrangement 40 and the detector 50, which aperture mask is configured to filter scattered light portions 70 passing through the microlenses 45 before said scattered light portions impinge on the reception surface 55 of the detector 50.

1-10. (canceled)

11. A lidar sensor, comprising:
a transmission unit;
a protective glass;
an objective;
a microlens arrangement; and
a detector;
wherein:
the transmission unit is configured to generate a laser light and to radiate the laser light via a transmission path of the lidar sensor into an environment of the lidar sensor,
the protective glass, the objective, the microlens arrangement, and the detector are arranged in a reception path of the lidar sensor and the objective is configured to image objects from the environment of the lidar sensor that are illuminated in the environment by the radiated laser light of the lidar sensor,
the microlens arrangement is arranged between the objective and the detector in such a way that scattered light generated in a region of the protective glass and useful light received from the environment are influenced by the microlens arrangement in such a way that a substantially separate use of the scattered light and of the useful light is made possible, and
the detector is configured to receive light influenced by the microlens arrangement and to convert it into a corresponding measurement signal.

12. The lidar sensor according to claim 11, wherein:
the microlens arrangement is a regular, grid-like, arrangement of a multitude of identical microlenses within a plane, and/or
the microlens arrangement is arranged between the objective and the detector in such a way that the microlens arrangement is substantially in an image plane, generated by the objective, of the protective glass.

13. The lidar sensor according to claim 11, further comprising:
an aperture mask;
wherein the aperture mask is arranged between the microlens arrangement and the detector and is configured to limit an aperture for each microlens of the microlens arrangement in such a way that potentially present scattered light portions are reduced by the limited aperture.

14. The lidar sensor according to claim 11, further comprising an evaluation unit, wherein:
a reception surface of the detector is arranged in respective focal planes of the microlenses of the microlens arrangement, and
the evaluation unit is configured to:
receive the measurement signal of the detector, and,
(i) generate, based a principle of light-field imaging, generate a useful light signal from the measurement signal, the useful light signal substantially represents useful light portion of received light, and/or (ii) generate a scattered light signal which substantially represents a scattered light portion of the received light.

15. The lidar sensor according to claim 14, wherein the evaluation unit is configured to ascertain a magnitude of the scattered light portion based on:
a width of a brightness distribution on a reception surface of the detector, and/or
a light intensity difference between pixels on the reception surface of the detector.

16. The lidar sensor according to claim 14, wherein the evaluation unit is configured to ascertain a cause of the scattered light portion and/or a position of the cause of the scattered light portion in a region of the protective glass using an image recognition method.

17. The lidar sensor according to claim 15, wherein the evaluation unit is configured to, depending on a magnitude and/or a cause and/or a position of the cause of the scattered light portion:
initiate a partial cleaning of the protective glass corresponding to the position of the cause of the scattered light portion, and/or
output an indication to a user of the lidar sensor, and/or
output a signaling to a system that uses the lidar sensor.

18. The lidar sensor according to claim 13, wherein:
the microlens arrangement is a first microlens arrangement and the lidar sensor includes a second microlens arrangement, and
the second microlens arrangement is arranged between the aperture mask and the detector and is configured to generate a back image, corresponding to an image by the first microlens arrangement, on a reception surface of the detector.

19. The lidar sensor according to claim 11, wherein the lidar sensor is a flash lidar or a line scanner.

20. An environment recognition system, comprising:
a lidar sensor, including:
a transmission unit;
a protective glass;
an objective;
a microlens arrangement; and
a detector;
wherein:
the transmission unit is configured to generate a laser light and to radiate the laser light via a transmission path of the lidar sensor into an environment of the lidar sensor,
the protective glass, the objective, the microlens arrangement, and the detector are arranged in a reception path of the lidar sensor and the objective is configured to image objects from the environment of the lidar sensor that are illuminated in the environment by the radiated laser light of the lidar sensor,
the microlens arrangement is arranged between the objective and the detector in such a way that scattered light generated in a region of the protective glass and useful light received from the environment are influenced by the microlens arrangement in such a way that a substantially separate use of the scattered light and of the useful light is made possible, and
the detector is configured to receive light influenced by the microlens arrangement and to convert it into a corresponding measurement signal.
